(19) United States
(12) Patent Application Publication
(10) Pub. No.: US 2009/0016814 A1
(43) Pub. Date: Jan. 15, 2009

(54) Connecting Device for an Actuator

(76) Inventor: Fu-Yuan CHENG, Taichung (TW)

Correspondence Address: Dr. BANGER SHIA, 102 Lindencrest Ct., Sugar Land, TX, 77479-5201, US

(21) Appl. No.: 11/778,027

(22) Filed: Jul. 14, 2007

(51) Int. Cl. F16H 27/00

(52) U.S. Cl. 403/294; 74/111

(57) ABSTRACT

A connecting device for an actuator comprises two actuators, a connecting assembly and a motor. Mandrels of the actuators are located correspondingly to each other, and lower ends of the actuators are connected to each other. A connecting assembly is provided for connecting the mandrels of the actuators, such that the actuators are combined with each other. A motor serves to drive the mandrel of one of the actuators, enabling the actuators to extend or retract simultaneously. Thereby, one motor can drive two actuators simultaneously, thus obtaining a double travel length by using only a single actuator, so the structure is simple and the cost is low, and the connecting device for an actuator is easy to assemble.

### BACKGROUND OF THE INVENTION

1. Field of the Invention

The present invention relates to an actuator, and more particularly to a connecting device for an actuator which utilizes one motor to drive two actuators simultaneously, so as to obtain a double travel length by using a single actuator.

2. Description of the Prior Art

A conventional actuator usually utilizes one motor to drive one actuator, as a result, the maximum travel length of such an actuator is the travel length available by using a single actuator, and in order to obtain a double travel length, another motor and actuator must be added. The longer the travel length is, the more motors and actuators will be, and it is difficult to assemble and the production cost is high.

The present invention has arisen to mitigate and/or obviate the afore-described disadvantages.

### SUMMARY OF THE INVENTION

The primary objective of the present invention is to provide a connecting device for an actuator which utilizes one motor to drive two actuators.

The present invention is characterized in that: the structure of the connecting device for an actuator is simple and is easy to assemble, two actuators are combined with each other to increase the travel length.

The connecting device for an actuator comprises two actuators, mandrels of the actuators are located correspondingly to each other, and lower ends of the actuators are connected to each other. A connecting assembly is provided for connecting the mandrels of the actuators, such that the actuators are combined with each other. A motor serves to drive the mandrel of one of the actuators, enabling the actuators to extend or retract simultaneously.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an assembly longitudinal cross sectional view of a connecting device for an actuator in accordance with the present invention;

FIG. 2 is an exploded longitudinal cross sectional view of the connecting device for an actuator in accordance with the present invention;

FIG. 3 is an enlarged longitudinal cross sectional view of the connecting device for an actuator in accordance with the present invention;

FIG. 4 is a transverse cross sectional view of showing the transmission of a motor;

FIG. 5 is a radial cross sectional view of showing a coupler being combined with a coupler sleeve in accordance with a first embodiment of the present invention;

FIG. 6 is a partial cross sectional of showing two actuators in accordance with a second embodiment of the present invention; and

FIG. 7 is another radial cross sectional view of showing the coupler being combined with the coupler sleeve in accordance with the second embodiment of the present invention.

### DETAILED DESCRIPTION OF THE PREFERRED EMBODIMENTS

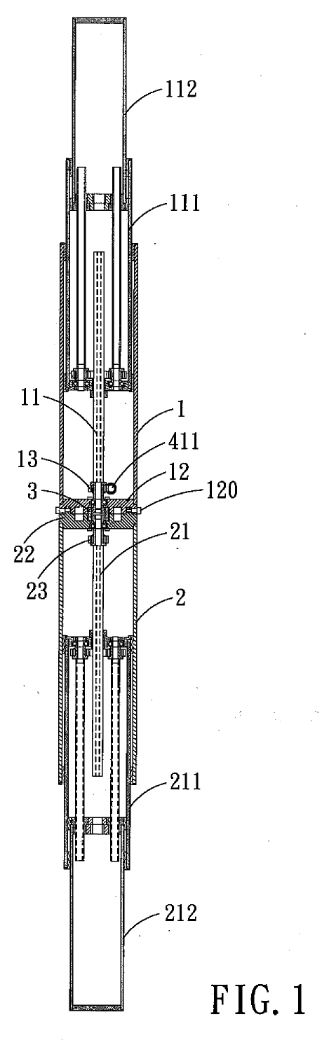

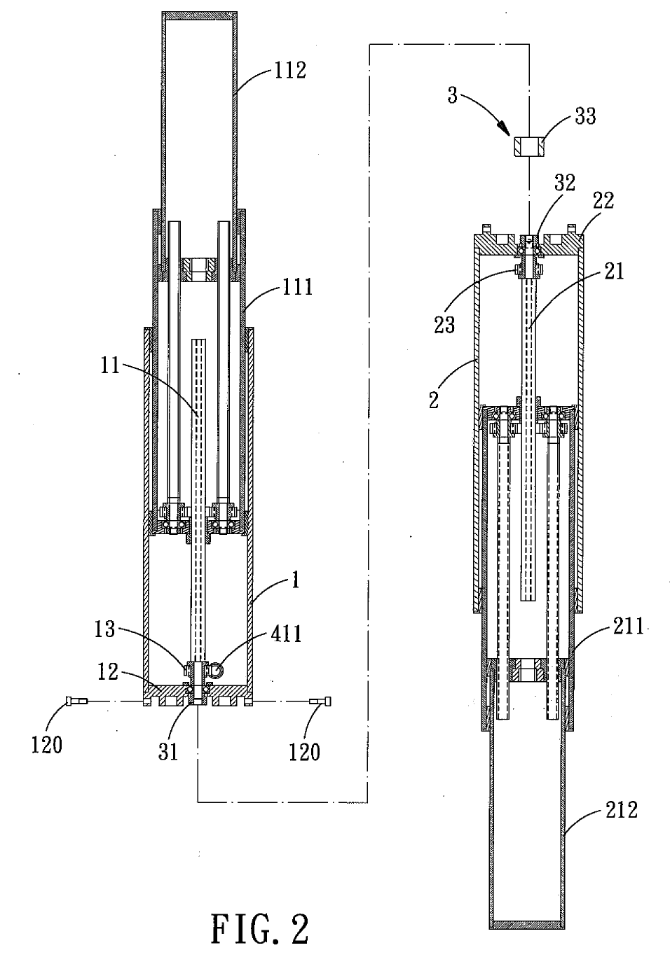

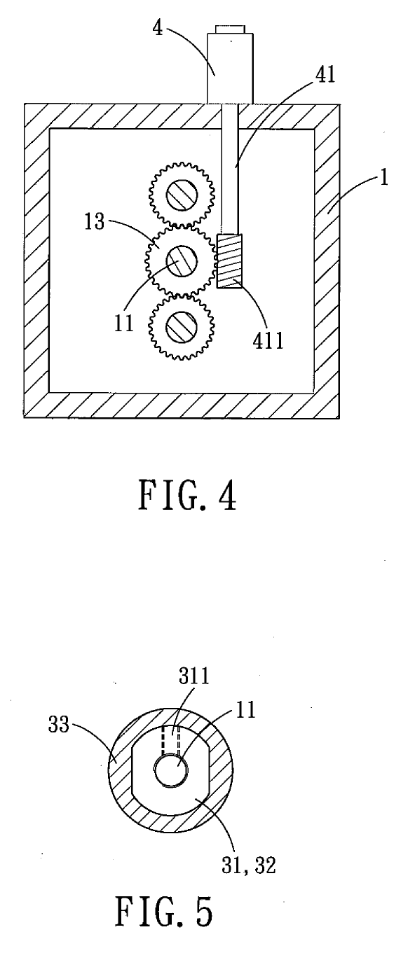

Referring to FIGS. 1-4, a connecting device for an actuator in accordance with the present invention comprises two actuators 1 and 2, a connecting assembly 3 and a motor 4.

Mandrels 11 and 12 of the actuators 1 and 2 are located correspondingly to each other, and a lower end 12 of the actuator 1 and a lower end 22 of the actuator 2 are connected to each other, and they can also be fixed by screws 120 so as to strengthen the connection therebetween.

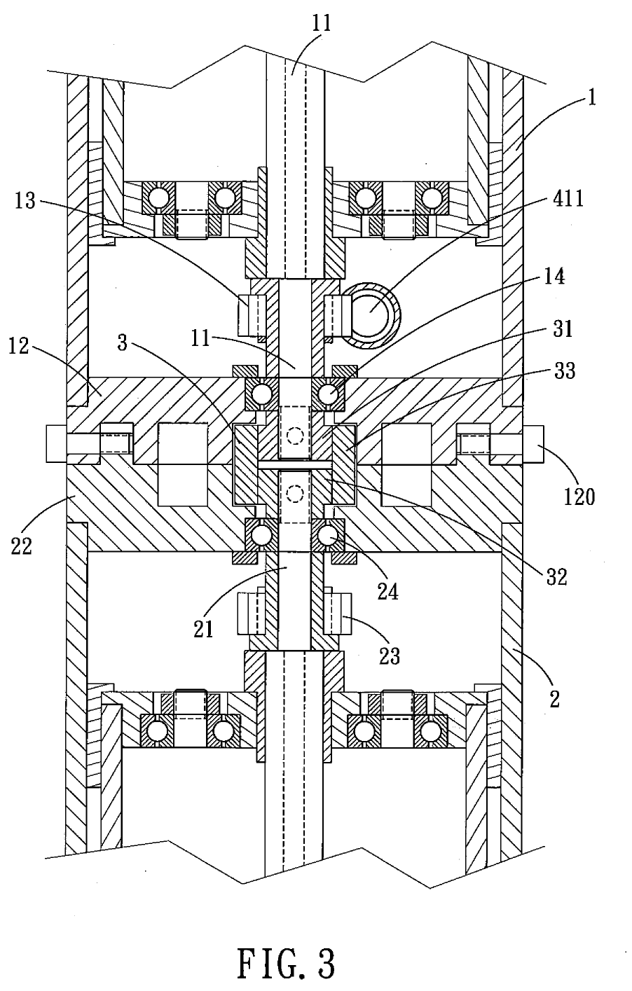

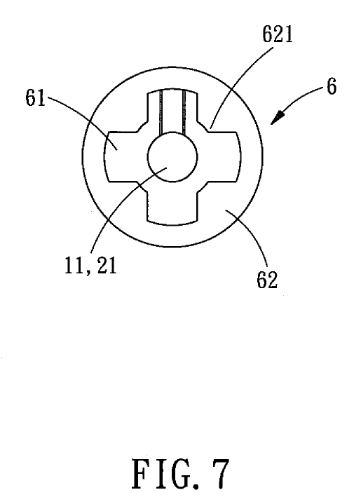

The connecting assembly 3 is provided for connecting the mandrels 11 and 21 of the actuator 1 and 2, such that the actuator 1 is combined with the actuator 2. In this embodiment, the connecting assembly 3 includes two couplers 31 and 32, and a coupler sleeve 33. The couplers 31 and 32 are threaded on the mandrels 11 and 21 of the actuators 1 and 2 respectively and are fixed by a grub screw 311 (shown in FIG. 5). The coupler sleeve 33 is mounted on the couplers 31 and 32 (shown in FIG. 3), and with the connecting assembly 3, the mandrels 11 and 21 of the actuators 1 and 2 can be combined with each other. The connecting assembly of another embodiment is shown in FIG. 7, a coupler 61 of the connecting assembly 6 is crisscross-shaped in cross section, and a coupler sleeve 62 must be formed with a crisscross groove 621 for insertion of the coupler 61.

The motor 4 utilizes a worm 411 mounted on an output shaft 41 to drive the mandrel 11 of the actuator 1.

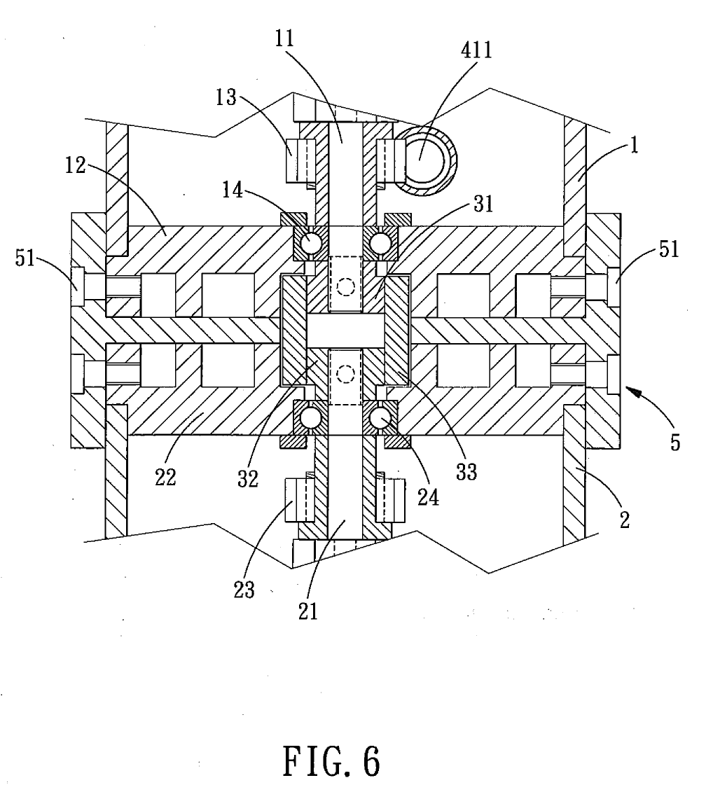

In addition, to ensure that the actuator 1 is combined with the actuator 2 more stably, the lower ends 12 and 22 of the actuators 1 and 2 are further disposed with a positioning seat 5 respectively as shown in FIG. 6, such that the lower ends 12 and 22 can be fixed to the positioning seats 5 simultaneously, enabling the actuator 1 to be combined with the actuator 2 stably. Moreover, the positioning seats 5 and the actuators 1 and 2 can be locked with each other by a plurality of screws 51.

The operation of the present invention is shown in FIGS. 1, 3 and 4, the mandrel 11 of the actuator 1 is mounted with a gear 13 and a bearing 14, and the mandrel 21 of the actuator 2 is mounted with a gear 23 and a bearing 24. When starting the motor 4, the worm 411 of the output shaft 41 drives the gear 13, the mandrel 11 and the coupler 31 to rotate, and since the coupler sleeve 33 is mounted on the couplers 31 and 32, the coupler 31 will rotate the coupler 32 via the coupler sleeve 33, so as to rotate the mandrel 21 of the actuator 2.

The worm 411 of the motor 4 can rotate the mandrel 11 of the actuator 1, in such a manner that a second section 111 and a third section 112 of the actuator 1 will extend out simultaneously. At the same time, the worm 411 of the motor 4 also rotates the mandrel 21 of the actuator 2, to make a second section 211 and a third section 212 of the actuator 2 extend outward. Thereby, the actuators 1 and 2 are extended simultaneously. And similarly, the actuators 1 and 2 can also be retracted simultaneously.

While we have shown and described various embodiments in accordance with the present invention, it should be clear to those skilled in the art that further embodiments may be made without departing from the scope of the present invention.

What is claimed is:

1. A connecting device for an actuator, comprising:
two actuators, mandrels of the actuators located correspondingly to each other, lower ends of the actuators connected to each other;
a connecting assembly for connecting the mandrels of the actuators, such that the actuators are combined with each other;
a motor serving to drive the mandrel of one of the actuators, enabling the actuators to extend and retract simultaneously.

2. The connecting device for an actuator as claimed in claim 1, wherein the connecting assembly includes two couplers and a coupler sleeve, the couplers are threaded on the mandrels of the actuators, respectively, and the coupler sleeve is mounted on the couplers.

3. The connecting device for an actuator as claimed in claim 1, wherein the lower ends of the actuators are further disposed with a positioning seat respectively, such that the lower ends are fixed to the positioning seats simultaneously, enabling the actuators to be combined with each other stably.

4. The connecting device for an actuator as claimed in claim 3, wherein the positioning seats and the actuators are locked with each other by a plurality of screws.

5. The connecting device for an actuator as claimed in claim 1, wherein the lower ends of the actuators are fixed by screws so as to strengthen the connection therebetween.
